(19) United States
(12) Patent Application Publication
(10) Pub. No.: US 2009/0089185 A1
(43) Pub. Date: Apr. 2, 2009

(54) Computer process (system/service) to facilitate shopping and delivery by allowing two parties or more than two parties to exchange (send and receive) physical items by using an email address (or a public identifier) of a receiving party and without the need to know a mailing/delivery address. A party could be a business or a consumer.

(76) Inventor: Samer A.S. Noures, Worcester, MA (US)

Correspondence Address: Samer A.S. Noures, 85 Park Ave Apt # 5, Worcester, MA, 01605, US

(21) Appl. No.: 12/284,381

(22) Filed: Sep. 22, 2008

Related U.S. Application Data
(60) Provisional application No. 60/974,151, filed on Sep. 21, 2007.

(51) Int. Cl. G06Q 30/00; G06F 7/06; G06F 17/30; G06Q 50/00

(52) U.S. Cl. 705/27; 707/3; 705/1; 707/E17.014

(57) ABSTRACT

A process, method, system, service to facilitate shopping, delivery and physical items exchange between businesses and/or individuals, this is achieved by allowing a sender to use an email address/a public identifier to send a physical item(s) to a receiver instead of using an actual delivery/mailing address of the receiver. In one embodiment a sender can send a physical item(s) he/she owns or has access to via a delivery entity (such as a delivery courier(s), ordinary mail services, etc) by using the email address/public identifier of the receiver. In another embodiment, the sender can choose/purchase a physical item(s) from a business and send it using the receiver's email address/public identifier, where it gets delivered to the actual mailing/delivery address by a delivery entity (delivery entity could be the business itself, a delivery courier(s), ordinary mail services, etc). In other embodiments, the sender can purchase and send a gift certificate(s) that the receiver can use to choose a physical item(s) to be sent using the email address/public identifier instead of the actual mailing/delivery address that the delivery entity delivers to. The sender (a business or an individual) can also use own email address/public identifier instead of the actual mailing/pickup address when sending a physical item(s). The sender can send a physical item(s) to himself/herself, another individual(s) or a business/businesses using the email address/public identifier of the receiver (or using the email addresses/public identifiers if there are multiple receivers).

### CROSS-REFERENCE TO RELATED APPLICATIONS

This application claims the benefits of provisional patent application Ser. No. 60/974,151 filed 2007 Sep. 21 by the present inventor.

### Federally Sponsored Research

Not applicable

### SEQUENCE LISTING OR PROGRAM

Not applicable

### BACKGROUND

1. Field

This application relates to the privacy of a mailing/delivery address and ease of use to making deliveries.

2. Prior Art

Many prior art patents focused on providing methods to help with the privacy of personal information including mailing/delivery addresses of individuals when doing online transactions, below are some of them

U.S. Pat. No. 7,412,422 Method and system for securing user identities and creating virtual users to enhance privacy on a communication network
U.S. Pat. No. 7,409,548 Maintaining confidentiality of personal information during E-commerce transactions
U.S. Pat. No. 7,240,035 Method and apparatus for masking private mailing address information by manipulating delivery transactions
U.S. Pat. No. 7,216,227 Method and system for controlling the use of addresses using address computation techniques
U.S. Pat. No. 7,213,748 Anonymous mailing and shipping transactions
U.S. Pat. No. 7,204,415 Methods and systems for providing secondary address information
U.S. Pat. No. 7,203,315 Methods and apparatus for providing user anonymity in online transactions

However, all of those prior art patents have major disadvantages when it comes to the privacy of the mailing/delivery address of a person such as
They offered solutions on how to help to protect the privacy of a personal information including the mailing/delivery address of the person who is doing an online transaction where a private identifier(s)/method(s)/key(s)/substitute(s) used to protect the privacy can't be shared with others other than the entity they're doing online business with or risk the privacy or the personal identity of the person, but they didn't offer solutions for people to exchange (send and receive) physical items by using identifiers such as email addresses that can be shared with others and used publicly without risking the privacy of the actual delivery/mailing addresses of people exchanging items.
They offered solutions to help to protect the privacy of the mailing/delivery addresses when doing online transactions by using mechanisms to generate private substitutes of the actual addresses before the online purchases/transactions can take place, however in addition to the extra steps to generate the substitutes to physical addresses, the extra time and the difficulties of having multiple addresses (substitute ones as well as the actual ones) no solutions were offered to allow the person to having a single permanent public substitute that is purely virtual, chosen and solely created by the person himself/herself (such as an email address) that can be shared with others to exchange (send/receive) physical items while keeping the actual mailing/delivery address private and while still delivering these sent items directly to the actual address/mailbox but not to substitute ones.
They offered solutions that are limited and focused on helping to protect the privacy of the mailing/delivery addressees when doing online transactions only but they offered no solutions in protecting the privacy of addressees when doing offline transactions such as when a person (a sender) directly sends an item(s) via a delivery courier/ordinary mail services to another person (a receiver).

### Advantages

Email is one of the most used technologies, if not the most used one, in addition most majority of people that use computers have email addresses. Businesses use the email system as a main communication method, they also use it to schedule events and meetings, check employee availability and create a calendar of events, and furthermore people exchange business cards using emails and so on. Many secure major websites/systems/portals require people to use email addresses as user names to access the systems. Major social networking web sites such as Facebook use email addresses to keep track and link members to each other. Due to the popularity of using emails for communication, bookkeeping and to stay connected with others in addition to the fact that the email address is a unique identifier comes the concept of this computer process to expand on those electronic methods and benefits and allow people to exchange (send and/or receive) physical items using email addresses (or public identifiers).

The process is a computer system/service that gives a party (a consumer or a business) the convenience to send a physical item(s) to another party (an individual or a business) using the receiving party's email address/public identifier or the receiving parties' email addresses/public identifiers (if there are multiple receivers) without the need to know the shipping/mailing address of the receiver (or at least the full shipping/mailing address).

The system when adopted in a large scale will potentially be a huge delivery and social network to exchange physical items and products using email addresses or public identifiers. People and businesses (suppliers stores, government agencies, banks, schools, hospitals, etc) nationwide (or internationally) will be identified by their email addresses or public identifiers. With this the entire shopping and delivery/shipping systems are expected to be reshaped where people as well as businesses will be exchanging email addresses/public identifiers only to easily and privately exchange (send and receive) items without the need to reveal their mailing/delivery addresses. Social culture in the communities is also expected to be impacted where the question that will spread between people would be “What's your email address so I can send you an item/items (gifts, products etc)” or “What are your email addresses so I can send an item/items to all of you?”.

The process will facilitate shopping as well as delivery and physical item exchange between businesses and/or individuals. This will be achieved by allowing the sender to use the email address/public identifier of the receiver and the computer system/service will automatically identify the receiver's actual mailing/delivery address, inform and send the necessary info to a delivery entity/a business (such as a shipping courier) or the same business where the physical item/product was purchased from in order to make the delivery to the receiver.

This service can be used to facilitate (at least) the following types of delivery:
Consumer to Consumer, to deliver personal physical items, items that consumers have access to, merchandises, gift products, gift cards or even food items from local businesses (suppliers/stores) or remote ones, etc.
Consumer to Business.
Business to Business, to deliver any business shipments.
Business to consumer, to deliver products and marketing items such as catalogs, etc.
Note:—A business is any entity that provides a service to customers, that include (but not limited to) both profit and non profit organizations such as suppliers, stores, government agencies, schools, hospitals, banks, etc.
   Why this process/service/system is different than other services?
The service and its value proposition are unique (and has a potential physiological aspect) in which an email system (or other mechanisms such as system portal, website, etc) is used to deliver actual products by using email addresses/public identifiers only and without the need to know the shipping/mailing addresses of the receivers.
The service helps to protect the privacy of the shipping/mailing addresses where people can publicly share their email addresses/public identifiers only in order to exchange items without revealing their addresses or their current whereabouts.
The service allows people to create their own (potentially) permanent virtual delivery addresses (by using public identifiers such as email addresses) that can be used to easily exchange (send/receive) physical items with other people and without revealing the actual mailing/delivery addresses.
The service allows the sender to send/ship an item without worrying about the receiver's location and regardless of his/her whereabouts either locally or overseas; and allows the receiver to receive the item anywhere either locally or overseas by updating the shipping/mailing address with his/her current address (even if the current address is temporary).
The service allows users to securely make updates to their mailing/shipping addresses in the system and all items received from senders (people, businesses, etc) that use the service will automatically be delivered without the need to notify the senders (people businesses, etc) of the change in address/the new address, also this help in keeping the new/changed address private.
The service reduces delivery mistakes as the user (an individual, business) is the one who needs to update, maintain and keep the mailing/shipping address in the system up to date.
Ease of use, e.g. a user can send an item(s) to one or many users by sending one email with an attachment (that virtually describes the physical item(s) to be sent) via an email system or by submitting one request via a shopping portal, a web site, etc. The user doesn't really need to know the shipping/mailing address of the users who will receive the item(s) rather their email addresses/public identifiers.
The ease of use offered by the service where people and businesses can easily exchange items using public identifiers such as email addresses will encourage people to exchange more gifts and items. This may have positive impact on people, relationships and communities.
Overseas deliveries will potentially become easier and more accurate with the service as there is no need for the sender to worry about the actual shipping/mailing address with a potentially unfamiliar address format to him/her rather only the email address/public identifier of the receiver who receive the item(s) overseas.
The service would reduce waste and cut cost as it allows businesses to receive confirmations from interested consumers before sending their products, items or marketing materials.
As the service/system will securely store every delivery and item exchange transaction, this will lead to having a database with data mining and business intelligence systems to allow businesses and individuals to understand a real market for any product as well as a shopping behavior of people and other info (as permitted by law) and use the info to forecast accordingly.
This service when adopted by businesses doesn't need to have a centralized warehouse to store and manage products (even though a warehouse can be used) rather it can rely on a network of registered suppliers and stores that are local in each community where people can exchange goods and products offered by those local/remote businesses by using email addresses/public identifiers of each others instead of the actual mailing/delivery addresses to initiate the deliveries. Fresh food items from local stores (part of the system network) can also be delivered as well by using this service and items can be delivered on the same day if they get sent from local stores; also there may be no shipping/mailing cost. In addition to the sense of Community that this service can offer as every local business and consumer is a potential user of the system.
This service can benefit and enhance existing services offered by businesses and shopping portals such as Amazon.com, eBay.com, 1800flower.com, etc and act as a broker between those businesses and other businesses as well as consumers to facilitate shopping and delivery.

### SUMMARY

In accordance to one embodiment a party can send a physical item(s) to another party using a public identifier instead of an actual mailing/delivery address of the receiving party.

### DRAWINGS

### Figures

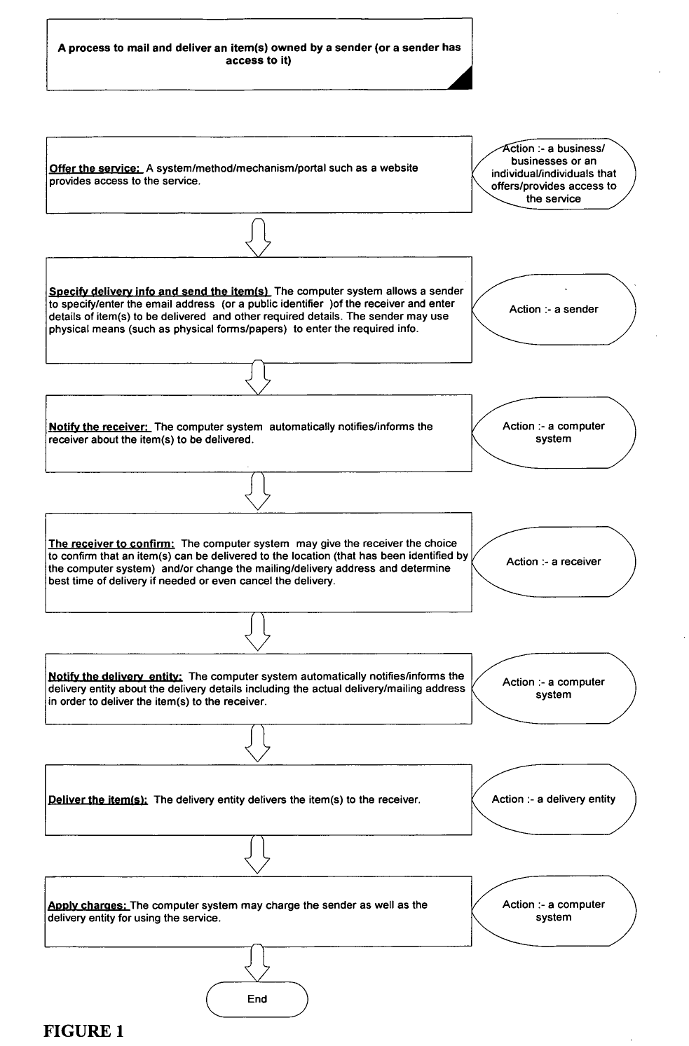

FIG. 1 is a flowchart that shows a process to mail and deliver an item/items owned by a sender or a sender has access to it.

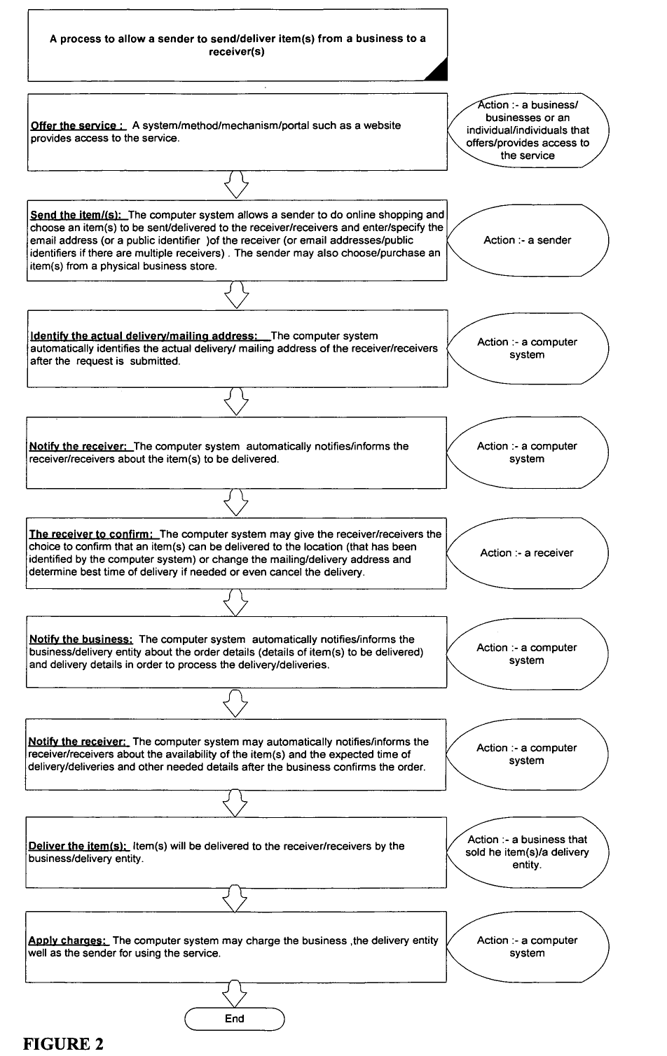

FIG. 2 is a flowchart that shows a process to allow a sender to send/deliver item/items from a business to receiver/receivers.

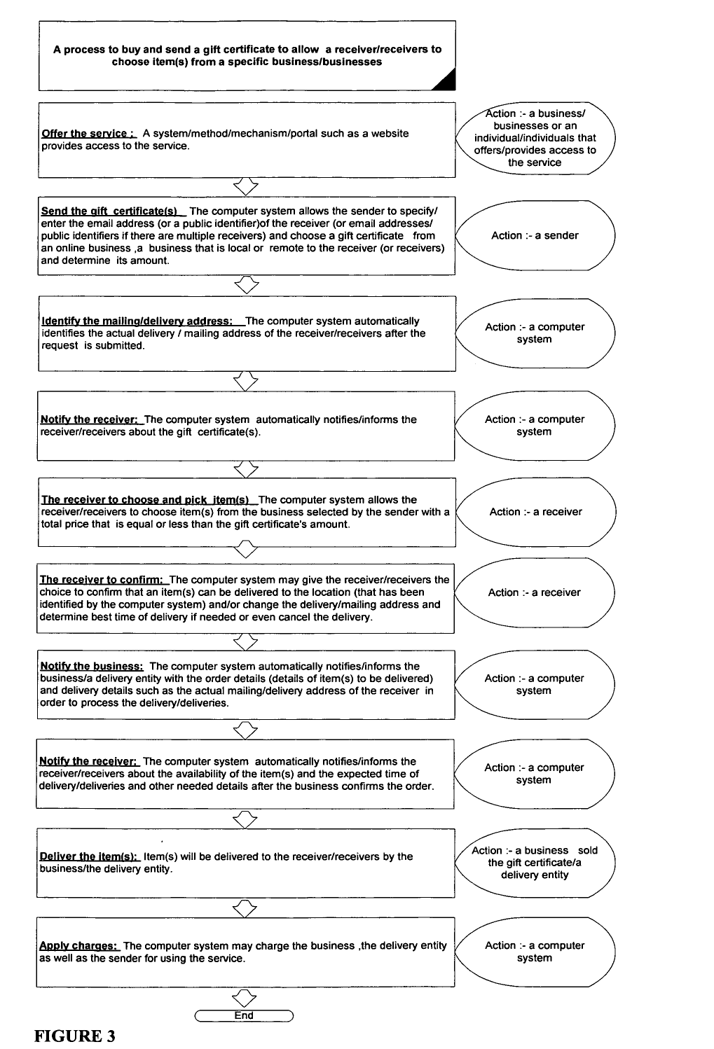

FIG. 3 is a flowchart that shows a process to buy and send a gift certificate to allow receiver/receivers to choose item/items from specific business/businesses.

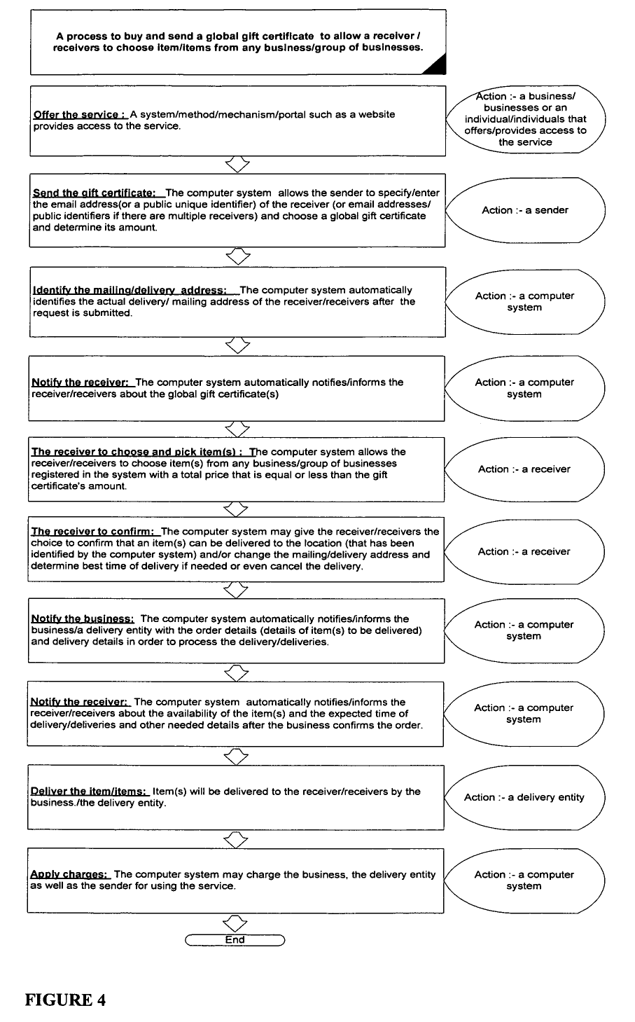

FIG. 4 is a flowchart that shows a process to buy and send a global gift certificate to allow a receiver/receivers to choose item/items from any business/group of businesses.

### DETAILED DESCRIPTION

### First Embodiment—FIG. 1

One embodiment relates to a process (system/service) to facilitate delivery by allowing two parties or more than two parties to exchange (send and receive) physical items by using the email address (or a public identifier) of the receiving party and without the need to know the actual mailing/delivery address. A party could be a business or a consumer. A business is any entity that provides a service to customers, that include (but not limited to) both profit and non profit organizations such as suppliers, stores, government agencies, schools, hospitals, banks, etc.

This process to mail and deliver an item(s) owned by a sender (or a sender has access to it) is comprised of the following:
The sender specifies/enters/writes an email address (or a public identifier) of the receiver and/or enters details of a pickup and/or item/items to be delivered if necessary either electronically or manually (on an envelope or a delivery slip). If the information is provided manually by the sender, a third party entity (such as a delivery/shipping courier) may take care of submitting the email address/public identifier of the receiver as well as other necessary info electronically to a computer system.
The computer system automatically identifies the receiver's actual shipping/mailing address from the submitted email address/public identifier (and potentially other info).
The computer system automatically notifies/informs the receiver about the item(s) to be delivered, and it may give the receiver the choice to confirm that the item(s) can be delivered to the mailing/shipping address that has been identified by the computer system or change the address and determine best time of delivery if needed or even cancel the delivery.
The computer system automatically notifies/informs the delivery entity (such shipping courier, ordinary mail services, etc) about the delivery details (including shipping/mailing address of the receiver, time of pickup, etc) in order to deliver the item(s) to the receiver.
The delivery entity delivers the item(s) to the receiver.
The computer system may charge the sender and/or the delivery entity for using the service.

### Notes:—

Order of process steps may change as needed. Some steps may be omitted and others may be added if necessary.
An item is any physical object, e.g. a shipment, a product, a gift card, etc.

### Operation

### First Embodiment—FIG. 1

Process could be facilitated through a web based system or an electronic system of any type, it can be any computer system, service, mechanism, method, program that uses (processes, analyzes) email addresses (or public identifiers) to automatically identify receivers' shipping/mailing addresses in order to facilitate shopping and exchanging (sending or receiving) physical items and products regardless of the process steps and structure. The process can be offered as a service via various methods, methods include but not limited to the following:
Offer the service via (or through) a portal system.
Offer the service via (or through) a website.
Offer the service via (or through) an email system.
Offer the service via (or through) a computer/a web service.
Offer the service via (or through) telecommunication systems and services such as cell phones.
Offer the service via an instant messenger system.
Use the service to offer a gift certificate/a global gift certificate where a user can buy from any store/supplier/business with an offered amount.
Use the service to offer “order and pick at store” service.

Process steps can be integrated and connected together using a computer system/process/service that would automate all/a few/parts of these steps where needed and where possible. Following are high level components that may be used in the system
Database servers to store profiles and system transactions.
Application servers to run the system services.
Application architectures and platforms.
Security systems
Network infrastructure & Internet access.
   The system for the process of the first embodiment can operate as the following
A user needs to create a profile in the system. The profile comprises of an email address, mailing/delivery address and other needed personal info. The system may use different means and mechanisms and require information intended to authenticate the user when creating the profile before the system grants an authorization to use the system. If the user (a sender) attempts to send a physical item(s) without having a profile, the system may reject the transaction and may notify the user electronically and/or by mail about the rejection and the need to create a profile. The system may give the user the ability to resume with the delivery transaction when a profile is created.
For the delivery, the user (the sender) specifies/enters/writes the email address/the public identifier of a user (a receiver) who will receive the sent physical item(s). The sender can provide the pickup and delivery info by using an electronic form/mechanism that feeds the system directly or by using a physical form/mechanism. If a physical form is used then a third party entity such as a delivery entity (e.g. a delivery courier, an ordinary mail service, etc) may take care of feeding the system with the delivery info. The sender or any third party involved with the delivery can have a direct or indirect access to the system where the delivery information can be fed though a third party system that is electronically linked to the system.
The system records the transaction(s) in a database(s) and flags it as a “pending” pickup and delivery transaction(s) once the delivery info that comprises of the email address/public identifier of the receiver and other details about the pickup address and the physical item(s) to be delivered is available.
The system uses the submitted email address/identifier to look up the actual mailing/delivery address of the receiver from the receiver's profile stored in the database(s) and electronically notifies a delivery entity (such as a delivery courier, ordinary mail services, a business, business store, etc) about the details of the transaction including the actual delivery address of the receiver. The system also looks up the sender's actual address from the database(s) where user profiles are stored, if the sender didn't specify the actual pickup address when the request for the delivery was submitted rather used an email address/public identifier instead, and notifies the delivery entity with the actual address of the sender along with other necessary info accordingly.
The system electronically notifies the receiver (sends an email to the receiver using the email address/public identifier specified by the sender) to create a profile (where the actual delivery address is specified), If the receiver doesn't have a profile in the system and before the delivery can be made. In the meantime the delivery entity doesn't make the delivery and may keep inquiring the system electronically to check whether it is able to get the actual delivery address of the receiver. After a predetermined period of time if the actual delivery address of the receiver still can't be obtained by the system for any reasons including a lack of the receiver's profile then the system flags the transaction as “cancelled” in the database(s), electronically notifies the delivery entity to cancel the delivery and notifies the sender about the cancellation electronically and/or by mail.
The system electronically notifies the receiver to check the current delivery address and update it if necessary If the receiver's profile already exists in the system, it may also allow the receiver to cancel the delivery if necessary.
The system continues to electronically keep the delivery entity up to date with the most recent delivery address as specified in the receiver's profile stored in the database(s) before the delivery is made and flags the transaction as “complete” after it gets electronically notified by the delivery entity that the physical item(s) is delivered.

Notes:
Orders of the steps may change as needed.
New steps may be added or exiting steps may be omitted as necessary.
Delivery can be handled by one or more than one delivery entities. The system can notify one or more than one delivery entities, if necessary, to deliver/help in making the delivery.

### Detailed Description

### Alternative Embodiment—FIG. 2

A process to allow a sender to send/deliver item(s) from a business to a receiver(s) is comprised of the following:
The computer system allows a sender to do shopping through a website/shopping portal/electronic system accessed via any device, choose the item(s) to be delivered and enter/specify the email address/public identifier (or email addresses/public identifiers if there are multiple receivers) of the receiver (either self or others) who will receive the purchased/chosen item(s). The computer system may also allow the sender to choose a business store (that will send the item(s)) that's local or remote to the receiver/receivers if a website/shopping portal aggregates the products and items from multiple (and maybe different) business stores that have physical presence in communities. The sender may also choose/purchase an item(s) from a physical business store and manually writes/enters/specifies the email address/public identifier (or email addresses/public identifiers if there are multiple receivers) of the receiver (either self or others) who will receive the chosen/purchased item(s) as well as other necessary info, with this the business store (or any other third party) may take care of submitting the email address/public identifier of the receiver as well as other necessary info electronically to the computer system.
The computer system automatically identifies the receiver's physical shipping/mailing address from the submitted email address/public identifier (and potentially other info).
The computer system automatically notifies/informs the receiver/receivers about the item(s) to be delivered, and it may give the receiver/receivers the choice to confirm that an item(s) can be delivered to the mailing/delivery address (that has been identified by the computer system) or change the address and determine best time of delivery if needed or even cancel the delivery.
The computer system automatically notifies/informs the business and/or a delivery entity with the order details (details of item(s) to be delivered) and delivery details in order to process the delivery/deliveries.
The computer system automatically notifies/informs the receiver/receivers about the availability of the item(s) and the expected time of delivery/deliveries and other needed details after the business confirms the order.
Item(s) gets delivered to the receiver/receivers by the business/the delivery entity.
The computer system may charge the business, delivery entity and/or the sender for using the service.

Notes:—
The system may also allow the receiver to pick the item/items from the business store if the receiver doesn't wish for the item/items to be delivered to the shipping/mailing address.
Order of process steps may change as needed. Some steps may be and omitted and others maybe added if necessary.

### Operation

### Alternative Embodiment—FIG. 2

The system can operate as the following
A user needs to create a profile in the system. The profile comprises of an email address, mailing/delivery address and other needed personal info. The system may use different means and mechanisms and require information intended to authenticate the user when creating the profile before the system grants an authorization to use the system. If the user (a sender) attempts to send a physical item(s) without having a profile, the system may reject the transaction and may notify the user electronically and/or by mail about the rejection and the need to create a profile. The system may give the user the ability to resume with the delivery transaction when a profile is created.
The system is electronically linked to a third party electronic system(s) such as a shopping portal/a website, a system that aggregates items and different businesses or a system used by a business/business store where an item(s) chosen/purchased by the sender will be sent to a receiver.
For the delivery, the sender specifies/enters/writes the email address/public identifier of a user (a receiver) who will receive the sent physical item(s). The sender can provide the info by using an electronic form/mechanism that feeds the system directly or by using a physical form/mechanism. If a physical form is used then a third party entity such as the business where the item(s) to be delivered was chosen/purchased from takes care of feeding the system with the delivery info. The sender or any third party involved with the delivery can have a direct or indirect access to the system where the delivery information can be fed though a third party system that is electronically linked to the system.
The system records the transaction(s) in a database(s) and flags it as a “pending” pickup and delivery transaction(s) once the delivery info that comprises of the email address/public identifier of the receiver and other details about the pickup address and the physical item(s) to be delivered is available.
The system uses the submitted email address/public identifier to look up the actual delivery address of the receiver from the receiver's profile stored in the database(s) and electronically notifies a delivery entity (such as a delivery courier, ordinary mail services, a business/business store where the item(s) to be delivered was chosen/purchased from, etc) about the details of the transaction including the actual delivery address of the receiver.
The system electronically notifies the receiver (sends an email to the receiver using the email address/identifier specified by the sender) to create a profile (where the actual delivery address is specified), If the receiver doesn't have a profile in the system and before the delivery can be made. In the meantime the delivery entity doesn't make the delivery and may keep inquiring the system electronically to check whether it is able to get the actual delivery address of the receiver. After a predetermined period of time if the actual delivery address of the receiver still can't be obtained by the system for any reasons including a lack of the receiver's profile then the system flags the transaction as “cancelled” in the database(s), electronically notifies the delivery entity to cancel the delivery and notifies the sender about the cancellation electronically and/or by mail.
The system electronically notifies the receiver to check the current delivery address and update it if necessary If the receiver's profile already exists in the system, it may also allow the receiver to cancel the delivery if necessary.
The system continues to electronically keep the delivery entity up to date with the most recent delivery address as specified in the receiver's profile stored in the database(s) before the delivery is made and flags the transaction as “complete” after it gets electronically notified by the delivery entity that the physical item(s) is delivered.

Notes:
Orders of the steps may change as needed.
New steps may be added or exiting steps may be omitted as necessary.
Delivery can be handled by one or more than one delivery entities. The system can notify one or more than one delivery entities to deliver/help in making the delivery.

### Detailed Description

### Alternative Embodiment—FIG. 3

A process to buy and send a gift certificate to allow a receiver/receivers to choose item(s) from a specific business/businesses
The computer system allows a sender to choose and purchase a gift certificate(s) (and choose a business if multiple businesses are available) from a website/shopping portal/electronic system (accessed via any device), determine its amount and specify/enter the email address/public identifier of the receiver (or email addresses/public identifiers if there are multiple receivers). The chosen business or the business that owns/operates the website(s)/shopping portal(s)/electronic system(s) may have physical locations that are local or remote to the receiver (or receivers) and may do the delivery or delegate it to a delivery courier(s). The sender may also choose/purchase the gift certificate from a physical business store/location and manually writes/enters/specifies the email address/public identifier (or email addresses/public identifiers if there are multiple receivers) of the receiver (either self or others) and other necessary info, with this the business store (or any other third party) may take care of submitting the email address/public identifier of the receiver as well as other necessary info electronically to the computer system.
The computer system automatically identifies the receiver's actual mailing/delivery address from the submitted email address/public identifier (and potentially other info).
The computer system automatically notifies/informs the receiver/receivers about the gift certificates(s) and other necessary info.
The computer system allows the receiver/receivers to choose item(s) from the business selected by the sender with a total price that is equal or less than the gift certificate's amount. This can be done through a website/shopping portal/electronic system accessed via any device.
The computer system automatically notifies/informs the business and/or delivery entity with the order details (details of item(s) to be delivered) and delivery details in order to process the delivery/deliveries.
The computer system automatically notifies/informs the receiver/receivers about the availability of the item(s) and the expected time of delivery/deliveries and other needed details after the business confirms the order. Also it may give the receiver/receivers the choice to confirm that an item(s) can be delivered to the delivery/mailing address (that has been identified by the computer system) or change the address and determine best time of delivery if needed or even cancel the delivery.
Item(s) gets delivered to the receiver/receivers by the business/delivery entity (such as a delivery courier(s)).
The computer system may charge the business, the delivery entity and/or the sender for using the service.

Note:—
The system may also allow the receiver to choose and pick the item/items or the gift card from the business store if the receiver doesn't wish for the item(s) to be delivered to the shipping/mailing address.

### Operation

### Alternative Embodiment—FIG. 3

The process could be facilitated through a web based system or an electronic system of any type. The system can operate as the following
A user needs to create a profile in the system. The profile comprises of an email address, mailing/delivery address and other needed personal info. The system may use different means and mechanisms and require information intended to authenticate the user when creating the profile before the system grants an authorization to use the system. If the user (a sender) attempts to send gift certificate(s) without having a profile, the system may reject the transaction and may notify the user electronically and/or by mail about the rejection and the need to create a profile. The system may give the user the ability to resume with the delivery transaction when a profile is created.
The system is electronically linked to a third party electronic system(s) such as a shopping portal/a website, a system that aggregates items and different businesses or a system used by a business/business store where a gift certificate(s)/a voucher(s)/a gift card(s) can be purchased by the sender.
For the delivery, the sender specifies/enters/writes the email address/the public identifier of a user (a receiver) who will receive the sent physical item(s) chosen through the gift certificate. The sender can provide the info by using an electronic form/mechanism that feeds the system directly or by using a physical form/mechanism. If a physical form is used then a third party entity such as the business where the gift certificate(s) was purchased form takes care of feeding the system with the delivery info. The sender or any third party involved with the delivery can have a direct or indirect access to the system where the delivery information can be fed though a third party system that is electronically linked to the system.
The system notifies the receiver about the gift certificate offered by the sender electronically or physically using a physical gift card and allows him/her to choose item(s) to be delivered from a specific business/businesses selected by the sender.
The system records the transaction(s) in a database(s) and flags it as a “pending” pickup and delivery transaction(s) once the delivery info that comprises of the email address/public identifier of the receiver and other details about the pickup address and the physical item(s) to be delivered is available.
The system uses the submitted email address/public identifier to look up the actual delivery address of the receiver from the receiver's profile stored in the database(s) and electronically notifies a delivery entity (such as a delivery courier, ordinary mail services, a business/business store where the item(s) to be delivered was chosen/purchased from, etc) about the details of the transaction including the actual delivery address of the receiver.
The system electronically notifies the receiver (sends an email to the receiver using the email address/identifier specified by the sender) to create a profile (where the actual delivery address is specified), If the receiver doesn't have a profile in the system and before the delivery can be made. In the meantime the delivery entity doesn't make the delivery and may keep inquiring the system electronically to check whether it is able to get the actual delivery address of the receiver. After a predetermined period of time if the actual delivery address of the receiver still can't be obtained by the system for any reasons including a lack of the receiver's profile then the system flags the transaction as “cancelled” in the database(s), electronically notifies the delivery entity to cancel the delivery and notifies the sender about the cancellation electronically and/or by mail.
The system electronically notifies the receiver to check the current delivery address and update it if necessary If the receiver's profile already exists in the system, it may also allow the receiver to cancel the delivery if necessary.
The system continues to electronically keep the delivery entity up to date with the most recent delivery address as specified in the receiver's profile stored in the database(s) before the delivery is made and flags the transaction as “complete” after it gets electronically notified by the delivery entity that the physical item(s) is delivered.

Notes:
Orders of the steps may change as needed.
New steps may be added or exiting steps may be omitted as necessary.
Delivery can be handled by one or more than one delivery entities. The system can notify one or more than one delivery entities to deliver/help in making the delivery.

### Detailed Description

### Alternative Embodiment—FIG. 4

A process to buy and send a global gift certificate to allow a receiver/receivers to choose item/items from any business/group of businesses.
The computer system allows the sender to choose and purchase a global gift certificate (that is accepted and recognized by many businesses) from a website/shopping portal/electronic system (accessed via any device), determine its amount, and specify/enter the email address/public identifier of the receiver (or email addresses/public identifiers if there are multiple receivers). The sender may also purchase the gift certificate from a physical business store/location and manually writes/enters/specifies the email address/public identifier (or email addresses/public identifiers if there are multiple receivers) of the receiver (either self or others) as well as other necessary info, with this the business where the certificate was purchased from (or any other third party) may take care of submitting the email address/public identifier of the receiver as well as other necessary info electronically to the computer system.
The computer system automatically identifies the actual shipping/mailing address of the receiver/receivers after the request is submitted.
The computer system automatically notifies/informs the receiver/receivers about the global gift certificate(s) and other necessary info.
The computer system allows the receiver/receivers to choose item(s) from any business (or a group of businesses) registered in/linked to the system with a total price that is equal or less than the gift certificate's amount. This can be done through a website/shopping portal/electronic system accessed via any device.
The computer system automatically notifies/informs the business/businesses and/or delivery entity (such as delivery courier(s)) with the order details (details of item(s) to be delivered) and delivery details in order to process the delivery/deliveries.
The computer system automatically notifies/informs the receiver/receivers about the availability of the item(s) and the expected time of delivery/deliveries and other needed details after the business (or businesses) confirm the order(s). Also it may give the receiver/receivers the choice to confirm that an item(s) can be delivered to the delivery/mailing address (that has been identified by the computer system) or change the address and determine best time of delivery if needed or even cancel the delivery.
Item(s) will be delivered to the receiver by the business/businesses/delivery courier(s).
The computer system may charge the business/businesses and/or delivery courier(s) as well as the sender for using the service.

Notes:—
An item is any physical object, e.g. a shipment, a product, a gift card, etc.
The system may also allow the receiver to choose the item(s) or the gift certificate from a business store if the receiver doesn't wish for the item(s) to be delivered to the delivery/mailing address.
Sender could be an individual or a business. A receiver could be an individual or a business. A business is any entity that provides a service to customers including (but not limited to) profit and non profit organizations such as suppliers, stores, government agencies, schools, hospitals, banks, etc.
A computer system is any system, mechanism, method, program, service etc that's installed on/functions from a local/remote computer or any web based system used/accessed via any method/device.
Order of process steps may change as needed. Process steps maybe added/omitted as needed/if necessary.

### Operation

### Alternative Embodiment—FIG. 4

The process could be facilitated through a web based system or an electronic system of any type. The system can operate as the following
A user needs to create a profile in the system. The profile comprises of an email address, mailing/delivery address and other needed personal info. The system may use different means and mechanisms and require information intended to authenticate the user when creating the profile before the system grants an authorization to use the system. If the user (a sender) attempts to send a global gift certificate(s) without having a profile, the system may reject the transaction and may notify the user electronically and/or by mail about the rejection and the need to create a profile. The system may give the user the ability to resume with the delivery transaction when a profile is created.
The system is electronically linked to a third party electronic system(s) such as a shopping portal/a website, a system that aggregates items and different businesses or a system used by a business/business store where a global gift certificate(s)/a voucher(s)/a gift card(s) can be purchased by the sender.
For the delivery, the sender specifies/enters/writes the email address/the identifier of a user (a receiver) who will receive the sent physical item(s) chosen through the global gift certificate. The sender can provide the info by using an electronic form/mechanism that feeds the system directly or by using a physical form/mechanism. If a physical form is used then a third party entity such as the business where the gift certificate(s) was purchased form takes care of feeding the system with the delivery info. The sender or any third party involved with the delivery can have a direct or indirect access to the system where the delivery information can be fed though a third party system that is electronically linked to the system.
The system notifies the receiver about the global gift certificate offered by the sender electronically or physically using a physical gift card and allows him/her to choose item(s) to be delivered from one business or multiple different businesses that recognize and accept the gift certificate.
The system records the transaction(s) in a database(s) and flags it as a “pending” pickup and delivery transaction(s) once the delivery info that comprises of the email address/public identifier of the receiver and other details about the pickup address and the physical item(s) to be delivered is available.
The system uses the submitted email address/identifier to look up the actual delivery address of the receiver from the receiver's profile stored in the database(s) and electronically notifies a delivery entity (such as a delivery courier, ordinary mail services, a business/business store where the item(s) to be delivered was chosen/purchased from, etc) about the details of the transaction including the actual delivery address of the receiver.
The system electronically notifies the receiver (sends an email to the receiver using the email address/identifier specified by the sender) to create a profile (where the actual delivery address is specified), If the receiver doesn't have a profile in the system and before the delivery can be made. In the meantime the delivery entity doesn't make the delivery and may keep inquiring the system electronically to check whether it is able to get the actual delivery address of the receiver. After a predetermined period of time if the actual delivery address of the receiver still can't be obtained by the system for any reasons including a lack of the receiver's profile then the system flags the transaction as “cancelled” in the database(s), electronically notifies the delivery entity to cancel the delivery and notifies the sender about the cancellation electronically and/or by mail.
The system electronically notifies the receiver to check the current delivery address and update it if necessary If the receiver's profile already exists in the system, it may also allow the receiver to cancel the delivery if necessary.
The system continues to electronically keep the delivery entity up to date with the most recent delivery address as specified in the receiver's profile stored in the database(s) before the delivery is made and flags the transaction as “complete” after it gets electronically notified by the delivery entity that the physical item(s) is delivered.

Notes:
Orders of the steps may change as needed.
New steps may be added or exiting steps may be omitted as necessary.
Delivery can be handled by one or more than one delivery entities. The system can notify one or more than one delivery entities to deliver/help in making the delivery.

### CONCLUSION, RAMIFICATIONS, AND SCOPE

Accordingly the reader will see that, according to various embodiments people can exchange physical items using each other's email addresses/public identifiers through various methods and/or processes.

While the above description contains many specificities, these should not be constructed as limitations on the scope of any embodiment, but as exemplifications of the presently preferred embodiments thereof. Many other ramifications and variations are possible within the teachings of the various embodiments. For example an email system where a sender can view various businesses and available physical items and choose/purchase a particular physical item(s) and attach it virtually to the email body and send the email to the receiver (using the email address of the receiver), this can also be a method where the actual physical item(s) chosen/purchased by the sender will get delivered to the receiver although the sender didn't use the actual mailing/delivery address of the receiver in order to send the physical item(s).

Thus the scope of the invention should be determined by the appended claims and their legal equivalents, and not by the examples given.

I claim:

1. A method to deliver a physical item to a receiver without using said receiver's delivery address by a sender, comprising
providing means for said sender to enter or specify a public identifier of said receiver, and
providing means to look up said delivery address of said receiver stored in a system, and
providing means to inform an entity who will make the delivery of said physical item about said delivery address of said receiver in order to make or help to make said delivery,
Whereby said physical item will be delivered with ease of use and with keeping said delivery address and whereabouts of said receiver private.

2. The method of claim 1 wherein said public identifier is virtual and could be an email address of said receiver.

3. The method of claim 1 wherein said public identifier can be shared with the public to deliver physical items to said receiver.

4. The method of claim 1 wherein said sender can keep a mailing address and other personal information private, for this a public identifier such as an email address can be used to mask said mailing address of said sender.

5. The method of claim 1, further including providing means for the user to create own profile and the virtual public identifier in said system or use an exiting one such as an existing email address to be used for deliveries.

6. The method of claim 1 wherein said physical item to be delivered to said receiver is an item owned by said sender, said sender has access to, said sender has obtained online, said sender has obtained from a business store.

7. The method of claim 1 wherein said entity is an online business, a store, an ordinary mail service, a delivery business or a delivery courier.

8. The method of claim 1, further including providing means for said sender to send multiple physical items.

9. The method of claim 1, further including providing means for said delivery be done through multiple entities.

10. The method of claim 1, further including providing means for said receiver and said sender to change said delivery address or cancel the delivery.

11. A method to deliver a physical item chosen by a receiver through a gift certificate offered by a sender without using said receiver's delivery address by said sender, comprising
providing means for said sender to enter or specify a public identifier of said receiver who'll use a gift certificate offered by a said sender, and
providing means for said receiver to choose said physical item using said gift certificate, and
providing means to look up said delivery address of said receiver stored in a system, and
providing means to inform an entity who will make the delivery of said physical item about said delivery address of said receiver in order to make or help to make the delivery,
Whereby said physical item will be delivered with ease of use and with keeping said delivery address and whereabouts of said receiver private.

12. The method of claim 11 wherein said public identifier is virtual and could be an email address of said receiver.

13. The method of claim 11 wherein said public identifier can be shared with the public to deliver physical items to said receiver.

14. The method of claim 11 wherein said sender can keep a mailing address and other personal information private, for this a public identifier such as an email address can be used to mask said mailing address of said sender.

15. The method of claim 1, further including providing means for the user to create own profile and the virtual public identifier in said system or use an exiting one such as an existing email address to be used for deliveries.

16. The method of claim 11 wherein said entity is an online business, a business store, an ordinary mail service, a delivery business or a delivery courier.

17. The method of claim 11 wherein said gift certificate is a electronic or a physical certificate.

18. The method of claim 11 wherein said receiver can choose physical items from one or multiple businesses.

19. The method of claim 11, further including providing means for a said delivery be done through multiple entities.

20. The method of claim 11, further including providing means for said receiver and said sender to change said delivery address or cancel the delivery.
